(19) United States
(12) Patent Application Publication
(10) Pub. No.: US 2026/0141095 A1
(43) Pub. Date: May 21, 2026

(54) METHOD OF EXCHANGING AND EXECUTING AN ARTIFICIAL INTELLIGENCE MODEL, AND ELECTRONIC DEVICE

(71) Applicant: Rohde & Schwarz GmbH & Co. KG, Muenchen (DE)

(72) Inventors: Francesco ROSSETTO, Muenchen (DE); Andreas ROESSLER, Columbia, MD (US); Andreas OELDEMANN, Muenchen (DE)

(21) Appl. No.: 18/952,287

(22) Filed: Nov. 19, 2024

(51) Int. Cl. G06F 21/62; G06F 21/60

(52) U.S. Cl. CPC G06F 21/6209; G06F 21/602

(57) ABSTRACT

A method of exchanging and executing an artificial intelligence, AI, model is described. The method includes receiving, by a data security circuit of an electronic device, encrypted AI model data, wherein the encrypted AI model data includes the AI model; decrypting, by a processing circuit of the electronic device, the encrypted AI model data, thereby obtaining decrypted AI model data; and executing, by the processing circuit, the AI model based on the decrypted AI model data. Further, an electronic device is described.

### FIELD OF THE DISCLOSURE

Embodiments of the present disclosure generally relate to a method of exchanging and executing an artificial intelligence model. Embodiments of the present disclosure further relate to an electronic device.

### BACKGROUND

Artificial intelligence models in general and machine-learning models in particular are becoming ever more common in a plurality of different kinds of electronic devices.

If the interoperability of a device under test with an electronic device employing such an artificial intelligence model is to be tested, it may be necessary to load and execute the actual artificial intelligence model employed on the electronic device.

As another example, if an artificial intelligence model is to be trained in conjunction with a further artificial intelligence model, it may also be necessary to load and execute the further actual artificial intelligence model

Due to intellectual property concerns, developers of artificial intelligence models may be reluctant to provide the full artificial intelligence model for testing devices under test in combination with the artificial intelligence model or for training another artificial intelligence model.

Thus, there is a need for a method of exchanging and executing an artificial intelligence model as well as for an electronic device that allow to perform secure interoperability tests of a device under test and/or secure training of an artificial intelligence model with a proprietary artificial intelligence model.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a method of exchanging and executing an artificial intelligence (AI) model. In an embodiment, the method comprises: receiving, by a data security circuit of an electronic device, encrypted AI model data, wherein the encrypted AI model data comprises the AI model; decrypting, by a processing circuit of the electronic device, the encrypted AI model data, thereby obtaining decrypted AI model data; and executing, by the processing circuit, the AI model based on the decrypted AI model data.

The term “plaintext AI model data” is understood to denote the AI model data in unencrypted form.

The disclosed methods are based on the idea to encrypt the AI model data comprising the AI model before the AI model data is transmitted to the electronic device. If the AI model data is to be stored on the electronic device, the encrypted AI model data is stored on the electronic device. Accordingly, the plaintext AI model data is not available, neither during transmission of the AI model data nor while the AI model is stored on the electronic device. Instead, the AI model data is only decrypted by the processing circuit for inference of the AI model, without the decrypted AI model data becoming available to an operator of the electronic device or to any other device. Thus, it is ensured that the potentially proprietary AI model does not unwantedly become available without consent of the developer or the provider of the AI model.

In general, the methods disclosed herein allow for inference of the AI model, without the plaintext AI model data of the corresponding AI model data becoming available to an operator of the electronic device or to other electronic devices.

For example, methods of exchanging and executing an AI model disclosed herein allow to securely test the interoperability of a device under test with the AI model.

As another example, methods of exchanging and executing an AI model disclosed herein allow to securely train a further AI model, for example a further machine-learning model, in conjunction with the AI model.

In an embodiment, the encrypted AI model data is saved in a memory of the electronic device and/or in an external memory connected to the electronic device. Thus, the AI model data is not available in plaintext in the memory and/or in the external memory, and hence cannot be utilized without permission of the provider of the AI model.

For example, the external memory may be a memory stick, e.g. an USB stick, an external hard drive, a memory card or any other suitable type of external non-volatile memory. As another example, the external memory may be integrated into a server that is connected to the electronic device. For example, the server may be configured to provide a cloud storage service, wherein the encrypted AI model data is available via the cloud storage service.

An aspect of the present disclosure provides that the AI model, for example, is a machine-learning model. In an embodiment, the AI model data may comprise an already pre-trained machine-learning model. Accordingly, the machine-learning model is fully functional and can be executed by the processing circuit after decryption of the AI model data. However, as the AI model data is encrypted, unauthorized usage of the machine-learning model is effectively prevented.

According to another aspect of the present disclosure, the AI model data, for example, is encrypted via an asymmetric encryption technique. Thus, different keys are provided for encrypting and decrypting the AI model data. Using an asymmetric encryption technique ensures a convenient and secure communication between a provider of the AI model and the entity receiving and executing the AI model.

In an embodiment, the AI model data may be encrypted by the provider of the AI model using a public key. After encrypting the AI model data with the public key, the encrypted AI model data may be transmitted to the entity receiving and executing the AI model. Herein, the term “key” is understood to denote a cryptographic key that is usable to encode data or to decode encrypted data.

In an embodiment, the entity receiving and executing the AI model may be a supplier of test and/or measurement instruments, or a manufacturer of a device that is configured to be interoperable with the AI model.

In an embodiment, the public key may be provided, for example, by the entity receiving and executing the AI model.

In an embodiment, the public key may be stored in a memory of the electronic device. The electronic device may be configured to transmit the public key from the memory to the provider of the AI model, such that the provider can encrypt the AI model data with the public key before transmission of the AI model data.

For example, the public key may be saved into the memory of the electronic device during manufacture of the electronic device. However, the public key may also be saved into the memory of the electronic device at a later point in time.

A further aspect of the present disclosure provides that the encrypted AI model data, for example, is decrypted by the processing circuit with a private key. In general, the private key may only be available to the particular entity receiving and executing the AI model.

As the private key does not have to be shared with anyone, the transmission of the encrypted AI model data from the provider of the AI model data to the entity receiving and executing the AI model is secure.

In an embodiment, the AI model data is decrypted by the processing circuit only for inference of the AI model. In other words, the AI model data is only decrypted by the processing circuit internally when executing the AI model. However, the decrypted AI model data is not made available in any way other than for executing the AI model. Thus, the AI model data cannot be accessed for any other purposes without consent of the provider of the AI model.

According to an aspect of the present disclosure, the private key, for example, is non-extractable from the electronic device. In other words, it is impossible for a third party to read out the private key from the electronic device.

For example, the private key may be stored in a read-protected portion of a memory of the electronic device. In an embodiment, the read-protected portion of the memory of the electronic device may require an additional password in order to be accessed.

In an embodiment, the private key has a time-limited validity. In other words, the private key can be used to decrypt the encrypted AI model data only for a predetermined time period. After the predetermined time period, the private key expires and cannot be used to decrypt the encrypted AI model data any more. Thus, it is ensured that the AI model can be executed only in the predetermined time period, which may be set by the provider of the AI model.

For example, the predetermined time period may be set to be a time period during which tests are to be performed on a device under test in combination with the AI model.

In an embodiment, the public key—private key pair may have a time-limited validity.

As another example, the predetermined time period may be set to be a time period during which a further AI model is to be trained in conjunction with the AI model.

In an embodiment, the AI model data may be received by the data security circuit over the air. Accordingly, the data security circuit of the electronic device may be configured to receive wireless radio frequency (RF) signals, wherein the wireless RF signals comprise the encrypted AI model data.

Herein, any suitable wireless communication protocol may be used by the data security circuit.

Alternatively or additionally, the AI model data may be received by the data security circuit via a wired connection. Accordingly, the data security circuit of the electronic device may be configured to receive wired radio frequency (RF) signals, wherein the wired RF signals comprise the encrypted AI model data.

Herein, any suitable wired communication protocol may be used by the data security circuit.

According to an aspect of the present disclosure, the AI model, for example, is configured to be interoperable with a further AI model. Accordingly, the AI model may be configured to receive and process output data of another AI model. Alternatively or additionally, the AI model may be configured to generate output data serving as an input for another AI model. In other words, the AI model may be a portion of a multi-sided AI model, for example of a two-sided AI model.

In an embodiment, the AI model may be an encoder portion of an autoencoder AI model. In another embodiment, the AI model may be a decoder portion of an autoencoder AI model.

According to another aspect of the present disclosure, the processing circuit, for example, is connected to a device under test, wherein the AI model executed by the processing circuit is interfaced with the device under test. Accordingly, the interoperability of the device under test and the AI model can be tested by the method according to the present disclosure.

In an embodiment, the electronic device is a test and/or measurement instrument. Accordingly, the AI model can be executed by the test and/or measurement instrument, wherein the AI model is interfaced with the device under test by the test and/or measurement instrument. Thus, the device under test can be tested in combination with the AI model without further electronic devices executing the AI model being necessary.

For example, the test and/or measurement instrument may be a signal analyzer, a spectrum analyzer, a wireless communication testing device, a vector network analyzer, an oscilloscope, for example a digital oscilloscope, or any other suitable type of test and/or measurement instrument.

In another embodiment, the device under test is a physical device that is established separately from the electronic device. Thus, the interoperability of the device under test being a physical electronic device with the AI model being executed on the electronic device can be tested by the method according to the present disclosure.

Another aspect of the present disclosure provides, for example, that the device under test is a software device, wherein the device under test is executed on a testing circuit of the electronic device. In other words, the device under test may be software that can be loaded and executed by the electronic device, for example by the electronic device being a test and/or measurement instrument. Thus, no further electronic devices are necessary for testing the interoperability of the software device under test with the AI model.

Embodiments of the present disclosure further provide an electronic device. In an embodiment, the electronic device comprises a data security circuit and a processing circuit. The electronic device is configured to perform one or more of the methods described above. In an embodiment, the electronic device may be configured to perform the method according to any one of the embodiments described above.

Regarding the further advantages and properties of the electronic device, reference is made to the explanations given above with respect to the method, which also hold for the electronic device and vice versa.

According to an aspect of the present disclosure, the electronic device, for example, is a test and/or measurement instrument. For example, the test and/or measurement instrument may be a signal analyzer, a spectrum analyzer, a wireless communication testing device, a vector network analyzer, an oscilloscope, for example a digital oscilloscope. However, it is to be understood that the electronic device may be established as any other suitable type of test and/or measurement instrument.

According to another aspect of the present disclosure, the electronic device, for example, is a communication network device. For example, the electronic device may be part of a wireless communication network, for example of a wireless communication network being configured to communicate via WLAN, 4G, and/or 5G New Radio.

In an embodiment, the communication network device is a base station. As another example, the communication network device may be a user equipment such as a smartphone, a tablet, or any other suitable type of smart device.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a system with an electronic device according to an embodiment of the present disclosure;

FIG. 2 schematically shows a system with an electronic device according to another embodiment of the present disclosure;

FIG. 3 shows a flow chart of a method of exchanging and executing an AI model according to an embodiment of the present disclosure;

FIG. 4 schematically shows a system with an electronic device according to yet another embodiment of the present disclosure;

FIG. 5 schematically shows an example implementation of a training of a multi-sided AI model in the system of FIG. 4; and

FIG. 6 schematically shows a system with an electronic device according to still another embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

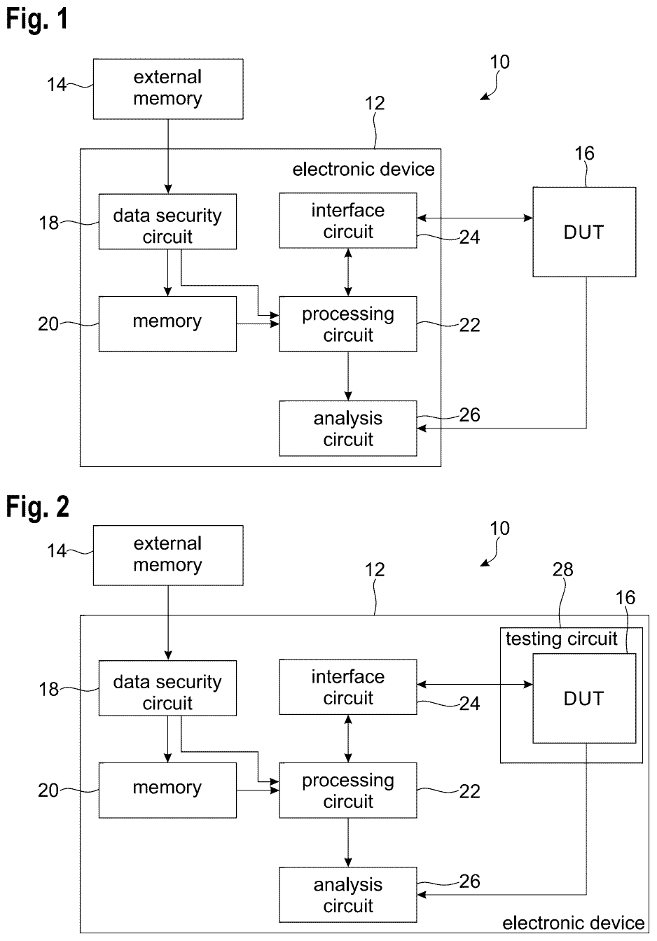

FIG. 1 schematically shows an example of a system 10 comprising an electronic device 12 and an external memory 14. In the example embodiment shown in FIG. 1, the system 10 is a test and/or measurement system that is configured to perform tests and/or measurements on a device under test 16. In an embodiment, the electronic device 12 may be a test and/or measurement instrument being configured to perform tests and/or measurements on the device under test 16.

For example, the electronic device 12 may be a signal analyzer, a spectrum analyzer, a wireless communication testing device, a vector network analyzer, or an oscilloscope, for example a digital oscilloscope. However, it is to be understood that the electronic device 12 may be established as any other suitable type of test and/or measurement instrument.

In the example embodiment shown in FIG. 1, the device under test 16 is an electronic device that is provided separately from the electronic device 12. For example, the device under test 16 may be a user equipment (UE) device being configured to communicate with other electronic devices, such as a mobile phone or a tablet. As another example, the device under test 16 may be a network device such as a node of a communication network, a router, a base station or a portion of a base station, etc.

In general, the electronic device 12 is configured to test an interoperability of the device under test 16 with an artificial intelligence (AI) model received from the external memory 14. Herein, the external memory 14 is a non-volatile memory that is provided separately from the electronic device 12. In an embodiment, the external memory 14 may be a memory stick, e.g. an USB stick, an external hard drive, a memory card or any other suitable type of external non-volatile memory. In another embodiment, the external memory 14 may be integrated into a server that is connected to the electronic device 12. For example, the server may be configured to provide a cloud storage service, i.e. the external memory 14 may be part of the cloud storage.

In an embodiment, the electronic device 12 comprise a data security circuit 18 that is connected to the external memory 14 in a signal-transmitting manner. For example, the data security circuit 18 may be connected to the external memory 14 via a wired connection and/or via a wireless connection.

In an embodiment, the electronic device 12 may further comprises a memory 20 that is provided downstream of the data security circuit 18. The memory 20 of the electronic device 12 may be a non-volatile memory.

In an embodiment, the electronic device 12 further comprises a processing circuit 22 that is connected to the data security circuit 18 and/or to the memory 20.

The electronic device 12 further comprises an interface circuit 24 that is provided downstream of the processing circuit 22. The interface circuit 24 is connected or connectable to the device under test 16. For example, the interface circuit 24 may be connected to the device under test 16 via a wired connection, for example via Ethernet. As another example, the interface circuit 24 may be connected to the device under test 16 via a wireless connection, for example via WLAN, 4G, and/or 5G.

In an embodiment, the electronic device 12 may comprise an analysis circuit 26 that may be connected to the device under test 16 and/or to the processing circuit 22.

FIG. 2 shows another embodiment of the system 10, wherein only the differences compared to the variant described above with reference to FIG. 1 are explained hereinafter. In the example embodiment shown in FIG. 2, the device under test 16 is not a physical electronic device but rather a software device that is to be tested by the electronic device 12. In an embodiment, the device under test 16 may be executed on a testing circuit 28 of the electronic device 12.

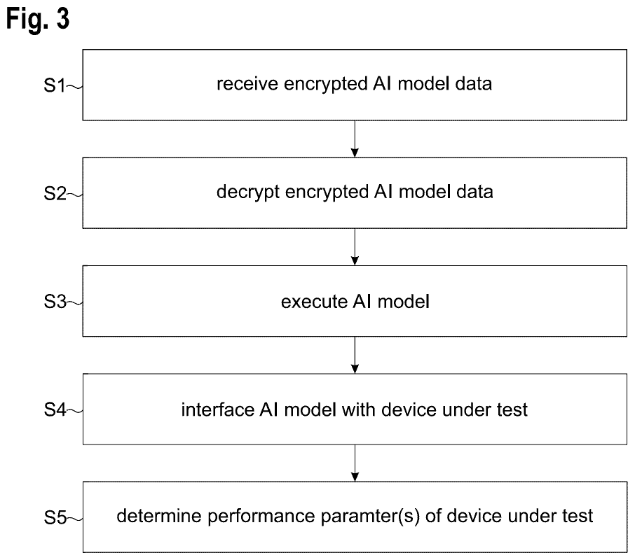

Regardless of the embodiment, the system 10 or the electronic device 12 is configured to perform a method of exchanging and executing an AI model, an example of which is described hereinafter with reference to FIG. 3.

Encrypted AI model data is received by the data security circuit 18 from the external memory 14 (step S1). For example, the encrypted AI model data may be transmitted from the external memory 14 to the data security circuit 18 on demand. In particular, an operator of the electronic device 12 may request the AI model data from the external memory 14, e.g. via a suitable user interface of the electronic device 12.

Alternatively, the AI model data may be automatically requested by the electronic device 12, for example based on a test to be performed or and/or based on the type of the device under test 16. For example, the encrypted AI model data may be transmitted from the external memory 14 to the data security circuit 18 on a pay-per-download basis.

In general, the encrypted AI model data comprises an AI model being configured to perform a certain functionality. For example, the AI model may be part of a multi-sided model, such as a two-sided AI model. In other words, the received AI model may be configured to be interoperable with at least one further AI model.

In an embodiment, the AI model may be a machine-learning model that has already been pre-trained in order to perform the certain functionality. In an embodiment, the AI model may be an encoder portion of an autoencoder or a decoder portion of an autoencoder. In an embodiment, the AI model may be configured to generate and encode a channel state information (CSI) report, or the AI model may be configured to decode an encoded CSI report.

It is noted that the encrypted AI model data may comprise, for example, a plurality of AI models, for example a plurality of interoperable AI models. The plurality of AI models may originate from the same provider or from different providers.

It is to be understood that the explanations given in the present disclosure likewise apply to the case of the AI model data comprising a plurality of AI models.

Without restriction of generality, the case of the AI model data comprising a single AI model is described hereinafter.

The encrypted AI model data has been encrypted prior to transmission of the AI model data to the electronic device 12. For example, the AI model data may have been encrypted using an asymmetric encryption technique, or more precisely a public key of a public key-private key pair.

According to an embodiment, the public key—private key pair may be generated by the electronic device 12, such that the private key is not known to any other party such as a manufacturer or provider of the electronic device 12. The public key may be stored in the memory 20 of the electronic device 12. The public key may be transmitted by the electronic device 12 to a provider of the AI model, which encrypts the AI model data using the public key and then stores the encrypted AI model data in the external memory 14.

According to another embodiment, the public key—private key pair may be generated by a manufacturer or provider of the electronic device 12, for example during manufacture of the electronic device 12. The public key may then be saved into the memory 20 of the electronic device 12, and may be provided to the provider of the AI model by the electronic device 12. Alternatively, the public key may be transmitted to the provider of the AI model by the manufacturer or provider of the electronic device 12.

In an embodiment, the provider may download the public key from a database comprising a plurality of public keys.

In general, the public key—private key pair may be valid only for the specific electronic device 12, for a plurality of specific electronic device, for a certain type and/or class of electronic devices, or for a plurality of types and/or classes of electronic devices.

In an embodiment, the encrypted AI model data may be stored in the memory 20 of the electronic device 12, and may afterwards be loaded into the processing circuit 22 from the memory 20. However, it is also conceivable that the encrypted AI model data may at least partially be loaded into the processing circuit 22 directly by the data security circuit 18.

It is emphasized that only the encrypted AI model data is saved in the external memory 14 and, optionally, in the memory 20 of the electronic device 12. Accordingly, the plaintext AI model data is not accessible by a third party at any point in time without consent of the provider of the AI model.

In an embodiment, the encrypted AI model data is decrypted by the processing circuit 22 using a private key corresponding to the public key used for encrypting the AI model data, thereby obtaining decrypted AI model data (step S2).

In an embodiment, the private key may be stored in the memory 20 of the electronic device 12, but in a way that prevents unauthorized access to the private key. In other words, the private key cannot be extracted from the electronic device 12.

For example, the private key may be stored in a read-protected portion of the memory 20, wherein additional authentication such as a password is necessary in order to access the read-protected portion. Optionally, the private key may have a time-limited validity, i.e. the validity of the private key may be restricted to a predetermined time interval. After the private key has expired, it cannot be used to decode the encrypted AI model data anymore.

In an embodiment, the public key - private key pair may have a time-limited validity. For example, the predetermined time interval may be defined by the provider of the AI model.

It is emphasized that the encrypted AI model data is decrypted by the processing circuit 22 only for inference of the AI model.

In an embodiment, the processing circuit 22 does not transmit the decrypted AI model data to any external electronic device(s), and the decrypted AI model data is not stored in the electronic device 12 in an accessible manner.

The AI model is executed by the processing circuit 22 based on the decrypted AI model data (step S3).

Further, the AI model being executed by the processing circuit 22 is interfaced with the device under test 16 by the interface circuit 24 (step S4).

In other words, the AI model being executed by the by the processing circuit 22 may receive an input signal from the device under test 16 via the interface circuit 24. The AI model executed by the by the processing circuit 22 may then process the input signal received from the device under test 16, thereby obtaining measurement data that may be forwarded to the analysis circuit 26.

Alternatively or additionally, the AI model executed by the by the processing circuit 22 may generate an output signal that is applied to the device under test 16. The device under test 16 may then process the output signal generated by the AI model, thereby obtaining measurement data that may be forwarded to the analysis circuit 26.

At least one performance parameter may be determined by the analysis circuit 26 based on the measurement data obtained (step S5). In general, the at least one performance parameter is indicative of a performance of the device under test 16 while operating in conjunction with the AI model executed by the processing circuit 22.

The at least one performance parameter determined depends on the functionality provided by the device under test 16 and/or on the functionality provided by the AI model. For example, if the device under test 16 comprises a decoder portion of an autoencoder, and the AI model corresponds to the encoder portion of the autoencoder, the at least one performance parameter may be a measure for how correct the device under test 16 retrieves data encoded by the AI model.

As another example, if the device under test 16 comprises a encoder portion of an autoencoder, and the AI model corresponds to the decoder portion of the autoencoder, the at least one performance parameter may be a measure for the amount of data that can be correctly retrieved by the AI model after the data has been encoded by the device under test 16.

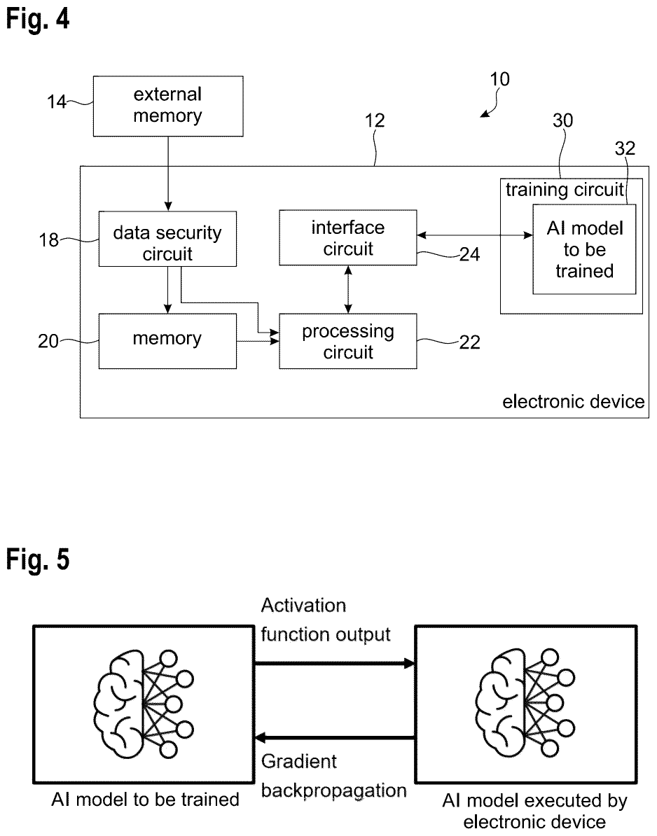

FIG. 4 shows another embodiment of the system 10, wherein the system 10 is configured to train a further AI model in conjunction with the AI model received from the external memory 14. Hereinafter, only the differences compared to the embodiments described above are explained.

In this embodiment, the electronic device 12 comprises a training circuit 30 that is configured to execute and train an AI model 32 to be trained. The AI model 32 to be trained may be a machine-learning model.

In the example embodiment shown in FIG. 4, the interface circuit 24 is provided between the processing circuit 22 and the training circuit 30. The interface circuit 24 is configured to interface the AI model executed by the processing circuit 22 with the AI model 32 to be trained.

In an embodiment, the system 10 or the electronic device 12 is configured to perform steps S1 to S3 of the method of exchanging and executing an AI model described above with reference to FIG. 3. Further, the training circuit 30 performs a training of the AI model 32 to be trained while the AI model 32 to be trained is interfaced with the AI model executed by the processing circuit 22.

This is illustrated in FIG. 5. In this example, the AI model executed by the processing circuit 22 receives an output signal from the AI model to be trained. The output signal is processed by the AI model executed by the processing circuit 22, thereby obtaining result data.

Based on the result data, the training circuit 30 adapts model parameters, for example weighting factors, of the AI model 32 to be trained, thereby training the AI model 32 to be trained. For example, the model parameters may be adapted by a gradient backpropagation. However, it is to be understood that any other suitable type of training technique may be used.

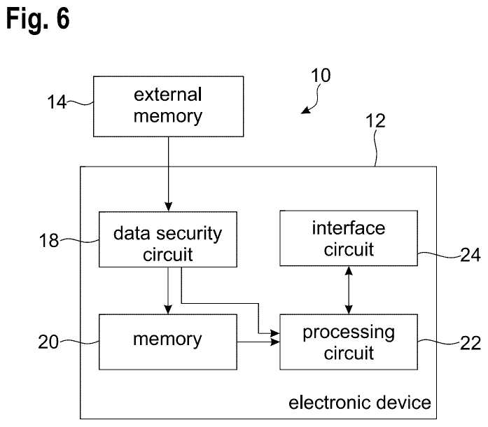

FIG. 6 shows another embodiment of the system 10, wherein the system 10 is a communication system. For example, the electronic device 12 may be a communication device that is configured to communicate with other electronic devices via a wireless connection and/or via a wired connection.

For example, the electronic device 12 may be a base station of a wireless communication network, such as a WLAN network, a 4G network, and/or a 5G network. As another example, the electronic device 12 may be user equipment (UE) device, wherein the UE device may be a smartphone, a tablet, or another type of smart device.

In the example embodiment shown in FIG. 6, the electronic device 12 may be configured to perform steps S1 to S3 described above.

In an embodiment, the interface circuit 24 may be a communication circuit, wherein the interface circuit 24 is configured to interface the AI model executed by the processing circuit 22 with another electronic device, for example another communication device.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, train AI models, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the electronic device 12, the external memory 14, the device under test 16 etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

It should now be appreciated that some embodiments of the present disclosure, or portions thereof, have been described in the general context of computer code or machine-useable instructions, including computer-executable instructions such as program modules, being executed by a computing system, or other machine or machines. Some of these embodiments or others may be implemented using a variety of system configurations, including handheld devices, consumer electronics, general-purpose computers, specialty computing devices, etc. Embodiments described herein may also be implemented in distributed computing environments, using remote-processing devices that are linked through a communications network or the Internet.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method of exchanging and executing an artificial intelligence (AI) model, the method comprising:
receiving, by a data security circuit of an electronic device, encrypted AI model data, wherein the encrypted AI model data comprises the AI model;
decrypting, by a processing circuit of the electronic device, the encrypted AI model data, thereby obtaining decrypted AI model data; and
executing, by the processing circuit, the AI model based on the decrypted AI model data.

2. The method of claim 1, wherein the encrypted AI model data is saved in a memory of the electronic device and/or in an external memory connected to the electronic device.

3. The method of claim 1, wherein the AI model is a machine-learning model.

4. The method of claim 1, wherein the AI model data is encrypted via an asymmetric encryption technique.

5. The method of claim 4, wherein a public key is stored in a memory of the electronic device.

6. The method of claim 1, wherein the encrypted AI model data is decrypted by the processing circuit with a private key.

7. The method of claim 6, wherein the AI model data is decrypted by the processing circuit only for inference of the AI model.

8. The method of claim 6, wherein the private key is non-extractable from the electronic device.

9. The method of claim 6, wherein the private key has a time-limited validity.

10. The method of claim 1, wherein the AI model data is received by the data security circuit over the air.

11. The method of claim 1, wherein the AI model data is received by the data security circuit via a wired connection.

12. The method of claim 1, wherein the AI model is configured to be interoperable with a further AI model.

13. The method of claim 1, wherein the processing circuit is connected to a device under test, wherein the AI model executed by the processing circuit is interfaced with the device under test.

14. The method of claim 13, wherein the electronic device is a test and/or measurement instrument.

15. The method of claim 13, wherein the device under test is a physical device that is established separately from the electronic device.

16. The method of claim 15, wherein the device under test is a software device, wherein the device under test is executed on a testing circuit of the electronic device.

17. An electronic device, the electronic device comprising a data security circuit and a processing circuit, wherein the electronic device is configured to perform the method of claim 1.

18. The electronic device of claim 17, wherein the electronic device is a test and/or measurement instrument.

19. The electronic device of claim 17, wherein the electronic device is a communication network device.

20. The electronic device of claim 19, wherein the communication network device is a base station.
